(19) United States
(12) Patent Application Publication
(10) Pub. No.: US 2008/0075818 A1
(43) Pub. Date: Mar. 27, 2008

(54) Production and processing of insects for transformation into protein meal for fish and animal diets

(76) Inventors: Ernest D. Papadoyianis, Boca Raton, FL (US); Xavier T. Cherch, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 11/903,996

(22) Filed: Sep. 25, 2007

Related U.S. Application Data
(60) Provisional application No. 60/847,600, filed on Sep. 27, 2006.

(51) Int. Cl. A23J 3/00

(52) U.S. Cl. 426/416

(57) ABSTRACT

A method of producing a high-protein insect meal for use as a fish, shrimp and animal feed by providing a closed, environmentally controlled mass insect production facility into which are introduced one or more species of insects that are rich in protein and particularly suited for use in fish, shrimp and animal feeds. The insects can be chosen from, but not limited to, the orders of Blattodea, Orthoptera, Diptera, or Lepidoptera. Also, the chosen insects can be of the species moths, butterflies, flies, beetles and crickets. The insects are then fed a food source which can be vegetable, grain, plant, or animal components, and fish and animal wastes. Upon reaching the desired life stage, the insects are harvested and then processed into a dried protein meal.

This non-provisional patent application is based on provisional patent application Ser. No. 60/847,600 filed on Sep. 27, 2006.

### BACKGROUND OF THE INVENTION

1. Field of the Invention

The present invention relates to methods for producing a protein meal and more particularly to methods for controlled cultivation of insects to be transformed into a protein meal.

2. Discussion of the Related Art

Commercial animal diets are based on protein as the primary ingredient. While the primary protein source varies depending upon the particular species being raised, all of the best quality animal-derived proteins (i.e. fish meal, poultry meal, etc.) have become very expensive and are often in short supply. Of the various protein sources, fishmeal is one of the most widely used. Fishmeal is used in varying quantities in the preparation of animal foods for swine, cattle, mink, dogs, cats as well as for commercial aquaculture. Additionally, fishmeal is used in the preparation of certain antibiotics for the pharmaceutical industry.

In 2005, the U.S. produced 255 million metric tons of fishmeal and imported another 60 million metric tons. Over 25% of all fish harvested in the ocean is used for fishmeal. The Aquaculture industry uses the majority of fishmeal for feed production. Not surprising, the supply of fish for use in the production of fishmeal is rapidly depleting and costs are escalating. Between the years 2005 and 2006, prices for prime fishmeal more than doubled.

Of these commercial feeds, aquaculture (the controlled production of fish, shellfish, and other aquatic animals and plants) is clearly dependent upon fishmeal as a primary dietary ingredient in most commercially milled diets. Currently, wild stocks of fish, menhaden in the U.S. and anchovies off the Peruvian coast, are being decimated for use in the production of fishmeal. This decimation has a two-fold effect. First, the source for fishmeal is depleting, and thus is becoming more expensive. Secondly, the depletion affects the availability of these fish as food sources for other larger predatory marine fish, resulting in a significant and detrimental impact on the eco-system and food chain. At the current rates of usage, wild baitfish stocks as a source for producing fishmeal and as a food source for wild marine fish are no longer sustainable.

Within the aquaculture industry, one of the highest priority research topics has been finding a suitable replacement for fishmeal. The industry's dependency on fish meal goes far beyond the shortage of supply and the burgeoning price. The growth of aquaculture coupled with the non-sustainable usage rate of wild stocks will result in the decline, or eventual elimination of the aquaculture industry. With aquaculture becoming an ever more important means of supplying freshwater and marine based foodstuffs (seafood), sustainability of the industry is of the utmost importance. From an economic perspective, every metric ton of fishmeal travels an average of 5,000 km to reach the end user. By locating sustainable mass insect production facilities in higher consumption areas, this economic liability could be alleviated.

Current research for a replacement protein meal has centered entirely on vegetable based proteins such as those derived from rice, corn, potatoes and peas. However, these meals are difficult to find, and typically are not as readily digested and assimilated as easily or as well as animal-based proteins. One form of animal based proteins for use in aquaculture is described in U.S. Pat. No. 3,939,802 suggesting the use of lights to attract wild insects to the surface of an aquaculture pond for the fish to feed upon. This device and method serves as only a supplemental food source and does not provide a complete source of protein meal for fish. Moreover, the usefulness of this device is seasonal and is not selective of insect species. Thus, a complete, year round production protein meal for fish containing only beneficial insect species cannot be achieved using the device and method disclosed in U.S. Pat. No. 3,939,802.

Accordingly, there remains a need for a sustainable source for a protein meal that is animal based and more readily represents the natural diet for use in fish and animal diets.

### SUMMARY OF THE INVENTION

One aspect of the present invention is a method of producing a high-protein insect meal for use as the sustainable protein source in fish, shrimp and animal feeds by providing a closed controlled mass insect production facility (environment) into which there is introduced one or more species of insects having high concentrations of protein, essential amino acids, and fatty acids that are particularly suited for use in fish, shrimp, and animal feeds. The insects can be chosen from, but are not limited to, the orders of Blattodea, Orthoptera, Diptera, or Lepidoptera. Also, the chosen insects can be of the species moths, butterflies, flies, crickets, or beetles. The insects are then fed a food source which can be plant, vegetable, grains, fruits, processed animal components, or fish/animal waste (fecal matter). Upon reaching the desired life stage, the insects are harvested, dried and then processed into a dried protein meal. Insect species can be specially selected based upon the available food source preference. Certain species will be selected that consume plant and grain based diets, while other insect species will be selected that consume fish and animal waste (fecal matter). Further, insect species can be selected based upon their specific nutritional profile, and in final processing, combined with other insect species whose nutritional profile provides a complementary benefit to the overall nutritional value of the meal. For example, a species containing a high protein profile could be combined with a species containing a high omega 3/6 fatty acid profile. In this manner, insect protein meal can be custom blended to suit the needs of different species of fish, shrimp, and animals.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a general diagram showing the sequence of steps of the insect meal production method of the present invention;

FIG. 2 is a general diagram of the insect meal production method of the present invention utilizing solid wastes, such as fish waste and/or livestock waste, as a food source to foster growth of insects in a mass insect production facility;

FIG. 3 is a general diagram of the insect meal production method of the present invention utilizing the by-products of ethanol and/or bio-diesel production as a food source to foster growth of insects in a mass insect production facility; and

FIG. 4 is a general diagram showing an example of the use of different insect species in the custom blending of insect meal formulas according to a further embodiment of the invention.

### DETAILED DESCRIPTION OF THE PREFERRED EMBODIMENTS

For purposes of description herein, a preferred embodiment and derivations thereof are disclosed. However, one will understand that the invention may assume various alternative orientations and step sequences, except where expressly specified to the contrary. It is also to be understood that the specific compositions and processes described in the following specification, are simply exemplary embodiments of the inventive concepts defined in the appended claims. Hence, specific quantities and other physical characteristics relating to the embodiments disclosed herein are not to be considered as limiting, unless the claims expressly state otherwise.

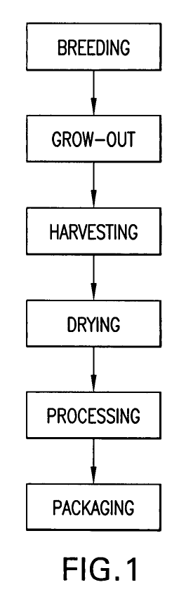

In accordance with the present invention, one of the preferred embodiments thereof for providing a protein meal includes the processing of insects into a dried meal as a very high protein source for many species of fish and shrimp. The protein meal is highly digestible and highly assimilated and also provides essential amino acids and fatty acids in the diets of many fish and shrimp. As shown in FIG. 1, a method of producing a protein meal includes the general steps of: breeding select species of insects; allowing the insect species to grow-out; harvesting the grown insects; drying the insects, processing (e.g., grinding, mixing) the dried insects; and packaging the insect protein meal. The use of insects for the production of a dried protein meal results in an ideally nutritious and sustainable protein source for fish, shrimp, and animal diets.

A controlled environment is essential for raising insects on a mass scale. A fully enclosed insect production facility will provide proper temperature and photo-period (light-dark) control for optimal reproduction and growth. While all facets of production and processing may be housed within one building, individual facets of the production and processing cycles are isolated within designated areas in the building optimized to provide proper control. The various designated areas include breeding, growing, harvesting, drying, grinding, and packaging.

The breeding area includes individual habitats for small groups of breeding insect stock. The breeding habitats are designed in such a way as to permit collection of eggs for removal and transplant into a grow out area. These habitats may incorporate a separation device such as a screen, or dual compartment cage to facilitate this transition. With certain species, different materials may be added to the habitat in either a free standing form, or attached to the ceiling of the habitat. These inserts serve as substrate for eggs to be laid, and can then be easily removed and relocated to the grow out habitat. Typically, several hundred of the small habitats are required to produce the necessary quantity of new insect eggs to later be grown and harvested. In the instances where the larval stages of the insects are intended for processing, they are mechanically separated from the growing media (food source) and moved to the harvesting and drying areas for processing. In the instances where adult stages are intended for processing, the larval insects are moved from the breeding areas to growing areas for further growth to harvest size.

The growing area contains significantly larger habitats wherein, for certain species, some of the habitats are walk-in areas allowing technicians to feed, clean, and harvest insects within the habitats. Other growing habitats are similar to the breeding habitats only on a larger scale. For certain species of insects, transitional two-stage habitats are utilized. In the two-stage habitats insect larvae are hatched and allowed to metamorphose into adults in the first stage of the habitat, and then allowed to crawl or fly through a specially formed passage into the second stage of the habitat. These insects are then grown to full size or are directly harvested from the second stage. The transitional habitat saves time and space in separating adult insects, and dramatically simplifies harvesting by the newly-formed adult insects separating themselves from the larvae, breeding stock, and food source.

Insect stocks for use are selected based upon a variety of factors. The insects chosen for the environment ideally exhibit fast growth characteristics; high reproduction rates; high fecundity; large biomass; provide maximum dry yield; high protein content; high fatty acid content; contain no toxins or off-flavor components; gregarious nature; short life cycle; disease resistant; ease of harvest; tolerate high stocking densities; have high food conversion rates; do not require excessive heating for reproduction and growth; and consume diets that are readily available, inexpensive to produce, and can incorporate a variety of ingredients. These characteristics insure that the selected insects will rapidly increase in volume by both quantity and size. Further, the insect's rapid rate of growth and reproduction will contribute to the size of the harvest as well as provide replacement stock for a new crop of insects, thus contributing to sustainability without relying on wild stocks. Insect species indigenous to each particular location will be used to avoid any potential environmental/ecological issues. Additionally, the closed controlled production facility is designed to prevent escapism, thus further avoiding environmental/ecological issues.

Further criteria for selection include the insect's nutritional characteristics with respect to the intended recipient of the final protein meal. Insects are a traditional food source for aquatic life such as fish. Individual species of fish have unique nutritional requirements which can be satisfied by the selection of insects comprising the source of the protein meal. Specific criteria to be considered for selection include the digestibility and assimilation of the insect meal, as well as the content of limiting amino acids for the species of fish or animal to be fed. Also of important consideration is the makeup of essential fatty acids and their respective ratios that the insect meal will provide for the diets of the particular species of fish or animal. Accordingly, the method of the present invention provides a scientifically formulated meal that can be regulated to contain particular beneficial nutrients and ingredients that are specific to the desired fish or animal diet.

Target insects can be, but are not necessarily limited to, cockroaches, flies, beetles, worms, larval stages of other flying insects such as meal worms, caterpillars, etc. The most desirable insects for use as a protein meal in terms of composition, size, reproduction, palatability, and lack of known toxins are typically species found within the orders:

a. Blattodea (roaches, cockroaches)

b. Orthoptera (grasshoppers, locusts, katydids, crickets)

c. Diptera (flies)

d. Lepidoptera (moths and butterflies)

### However, some insect species produce certain organic compounds that are distasteful or toxic and therefore are not suitable for inclusion in a dietary meal.

These undesirable compounds can be categorized in two classes. Class I compounds are those naturally occurring chemicals produced by the insects that will irritate, hurt, poison, or drug the fish which would feed on them. Class II compounds are those naturally occurring innocuous chemicals produced by the insects that, while not noxious to the fish feeding on the insects, would act as anti-feedants that merely stimulate the olfactory and gustatory receptors in the fish, or those which are aposematic indicators. The candidate insects will be screened for these compounds to deselect any insect species with these compounds.

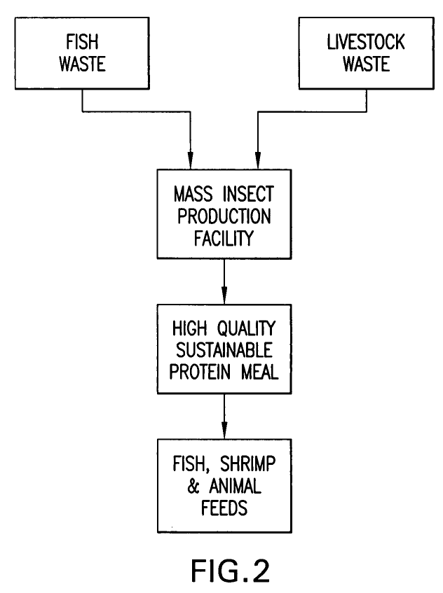

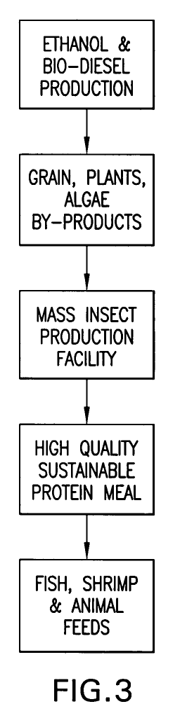

Once the desired insect species have been selected, the desired quantity of adult or larval insects is introduced into the closed growth environment. To foster the growth of the insects, a food source for the insects is also introduced into the growth environment. As exemplified in FIGS. 2 and 3, each growth environment would utilize a high-volume waste feed source such as fish and animal wastes, as well as processed or damaged fruits, vegetables, flowers, grains, plant material, or other like food sources. These food sources can further include the by-products of a processing plant utilizing animal or vegetable components from such processes as farming operations, grain processing, fruit processing, or ethanol and bio-diesel production.

Once an insect crop/population has reached the desired size and quantity to maximize the meal biomass, the insects are then separated from the introduced food source during the harvesting process. The harvesting process may include the use of vacuums, blower fans, washing stations, and screens/sieves to move and separate the insects according to the species and established production techniques. The insects are then dried in commercial belt and tumble driers depending on the species and life stage (larval or adult). Once the insects have been thoroughly desiccated, they are coarsely ground into meal. The finished meal is bagged and sold to various feed mills and diet manufacturers for incorporation into a variety of diets.

The above process is environmentally friendly and highly sustainable. The use of waste food sources alleviates the burden and negative impact these compounds currently have on the environment by the current practice of depositing them in landfills. The use of fish and animal wastes directly in a remediation process has an enormous impact on the environment by biologically utilizing a severe pollutant to produce a useable protein meal. Remediation of fish and animal wastes further prevents eventual direct and indirect contamination of our freshwater aquifers, rivers, lakes, stream and coastal waters. The practice of reproducing captive insect colonies as the source of the protein meal, eliminates the need to harvest the protein source from wild stocks of either insects or fish which would, in turn, have a detrimental impact on the environment for wild predators. Thus, the above process is sustainable without relying on introduction of resources harvested from the wild.

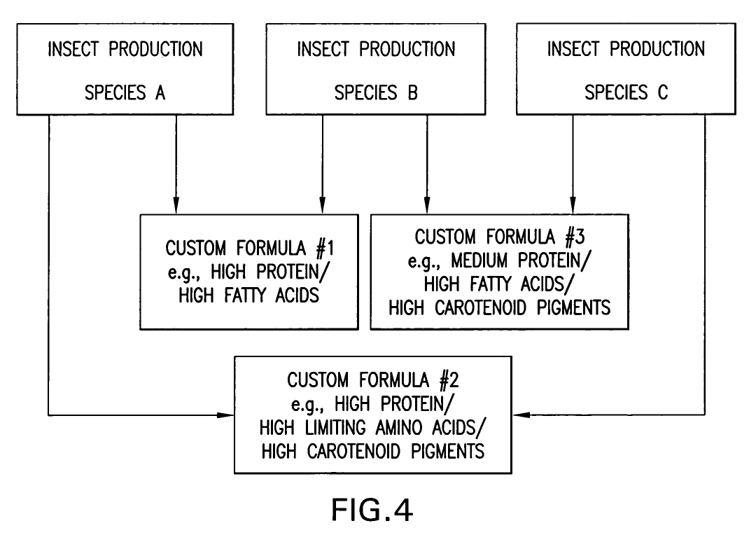

Insect species can be selected based upon their specific nutritional profile. In final processing, the insect species can be combined with other select insect species whose nutritional profile provides complementary benefit to the overall nutritional value of the desired meal product. In this manner, insect protein meal can be custom blended to suit the needs of different species of fish, shrimp, and animals. For example, as shown in FIG. 4, there are 3 different species of insects (species A, species B and species C), each possessing a different nutritional profile. Insect species A, for example, has a high protein and low fatty acid nutritional profile. Insect species B, on the otherhand, has a low protein and high fatty acids nutritional profile. Finally, insect species C presents a high percentage of limiting essential amino acids, high carotenoid pigments, and medium protein. Blending the processed insect species A with processed insect species B provides a custom formula #1, for example, that is high in protein and high in fatty acids. Similarly, combining the processed insect species A with the processed insect species C provides a custom formula #2, for example, that is high in protein, high in limiting amino acids and high in carotenoid pigments. Likewise, combining processed insect species B with processed insect species C provides a custom blended formula #3, for example, that is medium in protein, high in fatty acids, and high in carotenoid pigments. The above described formulas, based on blending different insect species as shown in FIG. 4, are for example purposes only. The custom blended dried meal formulas, according to the present invention, can be made to satisfy any of a large variety of overall nutritional values.

While the above description has been primarily directed to providing a dried protein meal directed to the needs of fish and animal diets, those practiced in the art will readily recognize that dried protein meal derived from insects could create crossover markets for human foodstuffs such as flours, breads, cereals, etc. in many areas of the world.

In the foregoing description, those skilled in the art will readily appreciate that modifications may be made to the invention without departing from the spirit and scope of the invention disclosed herein. Accordingly, the invention is not intended to be limited in scope except as defined in the claims as interpreted under the Doctrine of Equivalents.

We/I claim:

1. A method of producing a protein meal for dietary consumption, said method comprising the steps of:
establishing a contained environment for insect breeding;
selecting certain insect species for breeding;
introducing mature adult insects of the selected species into the contained environment for breeding;
providing nutrients to the selected insect species to foster growth of the selected species of insects;
harvesting larval and mature insects;
drying the harvested insects; and
processing the dried insects into a protein meal.

2. The method according to claim 1 wherein said selecting step includes:
selecting an insect species from at least one of the group of insect orders consisting of: Blattodea; Orthoptera; Diptera; and Lepidoptera.

3. The method according to claim 1 wherein said selecting step includes:
selecting an insect species from the group consisting of: moths; butterflies; flies; beetles; and crickets.

4. The method according to claim 1 wherein said selecting step excludes insects possessing noxious compounds that irritate, hurt, poison or drug an intended recipient of the protein meal.

5. The method according to claim 1 wherein said selecting step excludes insects possessing anti-feedant chemicals that stimulate olfactory receptors, gustatory receptors, or aposematic indicator odors.

6. The method according to claim 1 wherein said nutrient providing step further includes:
providing animal waste as nutrition for the selected species of insects, and thereby providing an animal waste remediation process.

7. The method according to claim 6 wherein said animal waste is fish waste.

8. The method according to claim 1 wherein said nutrient providing step further includes:
providing plant based nutrients to the selected insect species.

9. The method according to claim 1 wherein said nutrient providing step further includes:
providing grain based nutrients to the selected insect species.

10. The method according to claim 1 wherein said nutrient providing step further includes:
providing by-products from ethanol production to the selected insect species.

11. The method according to claim 1 wherein said nutrient providing step further includes:
providing by-products from bio-diesel production to the selected insect species.

12. The method according to claim 1 further comprising the steps of:
identifying nutritional profiles of different species of insects;
individually harvesting, drying and processing each of the different insect species to produce dried insect protein meal for each identified insect species; and
blending the processed dry insect meal of at least two of the identified insect species to produce a protein meal having a specific nutrient composition.

13. The method according to claim 1 wherein said step of processing includes:
grinding the dried insects.

14. A method of producing a protein meal for dietary consumption, said method comprising the steps of:
establishing a contained environment for insect breeding;
selecting certain insect species for breeding;
providing nutrients to the selected insect species to foster growth of the selected species of insects;
harvesting the selected insect species;
drying the harvested insects; and
processing the dried insects into a protein meal.

15. The method according to claim 14 wherein said selecting step includes:
selecting an insect species from at least one of the group of insect orders consisting of: Blattodea; Orthoptera; Diptera; and Lepidoptera.

16. The method according to claim 14 wherein said selecting step includes:
selecting an insect species from the group consisting of: moths; butterflies; flies; beetles; and crickets.

17. The method according to claim 14 wherein said nutrient providing step further includes:
providing animal waste as nutrition for the selected species of insects, and thereby providing an animal waste remediation process.

18. The method according to claim 14 wherein said nutrient providing step further includes:
providing plant based nutrients to the selected insect species.

19. The method according to claim 14 wherein said nutrient providing step further includes:
providing grain based nutrients to the selected insect species.

20. The method according to claim 14 further comprising the steps of:
identifying nutritional profiles of different species of insects;
individually harvesting, drying and processing each of the different insect species to produce dried insect protein meal for each identified insect species; and
blending the processed dry insect meal of at least two of the identified insect species to produce a protein meal having a specific nutrient composition.
